(19) United States
(12) Patent Application Publication
(10) Pub. No.: US 2008/0092507 A1
(43) Pub. Date: Apr. 24, 2008

(54) Corn head with tension control for deck plates

(75) Inventor: Dennis E. Bollig, Fenton, IA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Dragotec USA, Inc., Fenton, IA (US)

(21) Appl. No.: 11/583,370

(22) Filed: Oct. 18, 2006

(51) Int. Cl. A01D 45/02

(52) U.S. Cl. 56/106

(57) ABSTRACT

A corn head includes a tension control system that adjusts tension or biasing force of each deck plate of the corn head based upon user inputs, sensor signals, or both.

### BACKGROUND OF THE INVENTION

The present invention relates to an apparatus that controls the tension on the deck plates of a corn head.

A corn head for a combine removes ears of corn from the stalks and conveys them to a collection container. Gathering points, which are located on the front of the corn head, guide the stalks in each row of corn to a row unit, which includes a pair of spaced deck plates, a pair of chains with lugs, and a pair of stalk rolls. The stalks are guided into a gap between the pair of deck plates. The stalks are held upright on the deck plates while stalk rolls, which are located below the deck plates, pull the stalks downward and separate the ears from the stalks. The ears remain on the deck plates, and are moved rearward by the lugs of the chains. The ears are then conveyed by a cross auger to a collection container.

Field tests have shown that the width between the deck plates is critical to the yield, and as little as a ⅛ inch misadjustment will lead to a loss of bushels per acre. For example, if the gap is too wide, the ear is not separated from the stalk and falls between the deck plates. If the gap is too narrow, the stalks can become jammed in the corn head. The optimal width depends on many factors, including the variety of corn, the thickness of the stalks and the size of the ears. It may even vary between rows in the same field. Therefore, it is known in the art to have a system to adjust the gap width between the deck plates. In addition, some systems include a spring-loaded piston that is attached to each deck plate. The spring bias allows the deck plates to move from their set positions to automatically self-adjust the gap width based on the thickness of the stalks.

However, the optimum spring biasing forces to be applied to the deck plates vary for different types of corn. For example, it is preferred that the deck plates are locked at a given gap width when harvesting popcorn to keep the small, pointed ears from jamming between the deck plates, while it is preferred that the deck plates automatically self-adjust the gap width for field corn. Additionally, the optimal biasing force (or tensioning) differs depending on the weather conditions, such as the humidity and temperature. For example, low humidity causes the stalks to be dry and brittle. When these stalks are harvested, the leaves easily break from the stalks and sit on the deck plates. This extra material on the deck plates restricts the ability of the deck plates to separate the ear from the stalk. This problem is known as fluff. If less biasing force is applied to the deck plates in this situation, the deck plates are easier to push away from their set position. Therefore, there is less leaf breakage and fluff, and the automatic, self-adjusting gap width feature of the deck plates is still utilized.

Previously, the biasing force of each individual deck plate was adjusted by manually changing the spring tension of each of the spring-loaded pistons. This was very time consuming; the combine operator had to stop and exit the combine to either increase or decrease the spring tension of the piston for each deck plate by hand. For example, a common 8-row corn head has required that sixteen spring-loaded pistons be individually adjusted. Additionally, because the spring tension of each piston is individually adjusted, it is difficult to achieve the same bias force setting for all of the pistons.

### BRIEF SUMMARY OF THE INVENTION

The current invention presents an apparatus that adjusts the tension or biasing force applied to deck plates of a corn head for a combine. The biasing force applied to the deck plates affects how easily the deck plates may be displaced from their rest or set position. In one embodiment, the apparatus automatically changes the tension without manual adjustments in response to a user input or in response to sensed conditions such as humidity and temperature. The tension of all of the deck plates may be adjusted substantially simultaneously to the same value, or the tension for each pair of deck plates may be automatically and individually adjusted.

### BRIEF DESCRIPTION OF THE DRAWINGS

FIG. 1. is a perspective view of a corn head.

FIG. 2 is a perspective view of a portion of the corn head of FIG. 1 with parts removed to show a row unit.

FIG. 3 is an exploded view of the row unit of FIG. 2 with portions removed for clarity.

FIG. 4 is a top view of a portion of the row unit.

FIG. 5 is a perspective view showing the deck plate tensioning mechanism.

FIG. 6 is a perspective view showing the connection of a pneumatic actuator and the deck plate to the deck plate tensioning mechanism.

FIG. 7 is a bottom view of the pneumatic actuator connected to the deck plate tensioning mechanism.

FIG. 8 is an exploded diagram of a pneumatic actuator used to provide adjustable deck plate tension in the row of assembly of FIG. 4.

FIG. 9 is a schematic diagram of the corn head showing one embodiment of the present invention.

### DETAILED DESCRIPTION

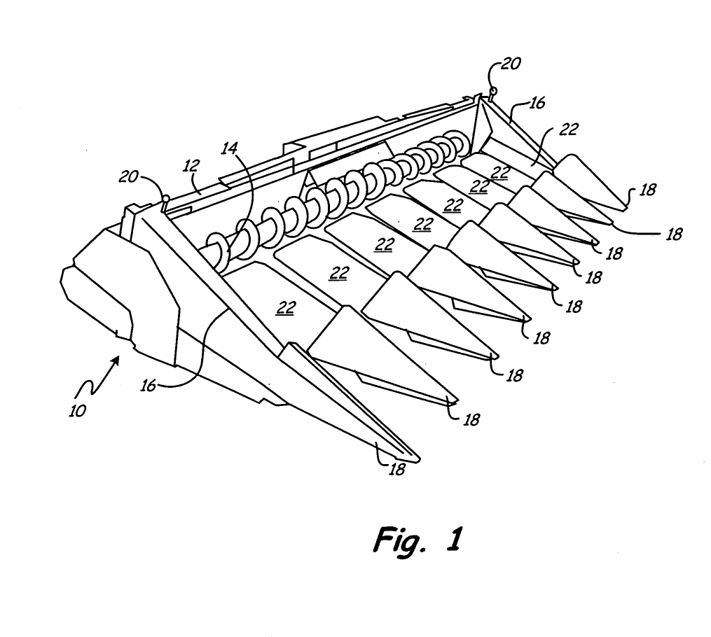

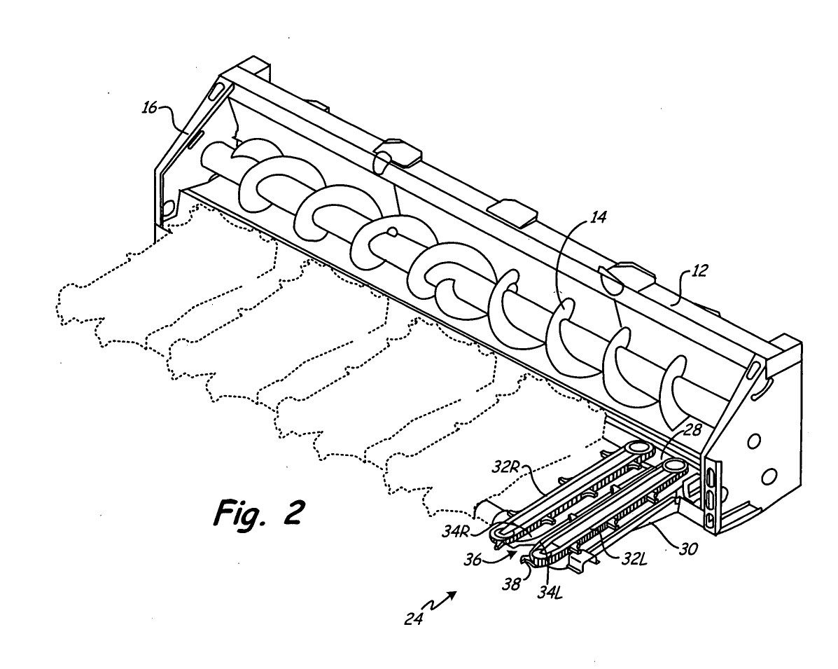

FIG. 1 shows corn head 10, which includes of unit frame 12, auger 14, side boards 16, gathering points 18, warning lights 20 and bonnets 22. Unit frame 12 connects to a combine (not shown), as is known to those skilled in the art. Auger 14 is housed inside of unit frame 12. Side boards 16 are attached to the ends of unit frame 12. Gathering points 18 are connected to and extend forward from unit frame 12. Warning lights 20 are mounted on side boards 16 to show where the ends of corn head 10 are. Bonnets 22 are located between auger 14 and gathering points 18 and are connected to unit frame 12. Bonnets 22 protect the row units that are located underneath them. Each adjacent pair of gathering points 18 guides the corn stalks in one row to row unit 24 (shown in FIG. 2) where the ears are removed and the stalks are cut. The ears move rearward to auger 14 and are then transported by auger 14 to entrance 26 of a feeder housing, where they enter a grain processing unit of the combine (not shown).

FIG. 2 shows a portion of corn head 10 with gathering points 18 and bonnets 22 removed so that one of row units 24 can be seen. Row unit 24 includes main gearbox 28, row unit frame 30, counter-rotating opposed chains 32L and 32R, opposed deck plates 34L and 34R that define gap 36, and a pair of stalk rolls (not shown) mounted below deck plates 34L and 34R.

Row unit 24 detaches the ears of corn from the corn stalks, and conveys them to auger 14. The ears and stalks of a row of corn are guided by gathering points 18 into gap 36 between deck plates 34L and 34R. The ears and stalks are propelled by lugs 38 on counter-rotating chains 32L and 32R, which are located above deck plates 34L and 34R. The ears are held upright on deck plates 34L and 34R while the stalk rolls below deck plates 34L and 34R cut the ears off of the stalks as the stalks are moved downwardly.

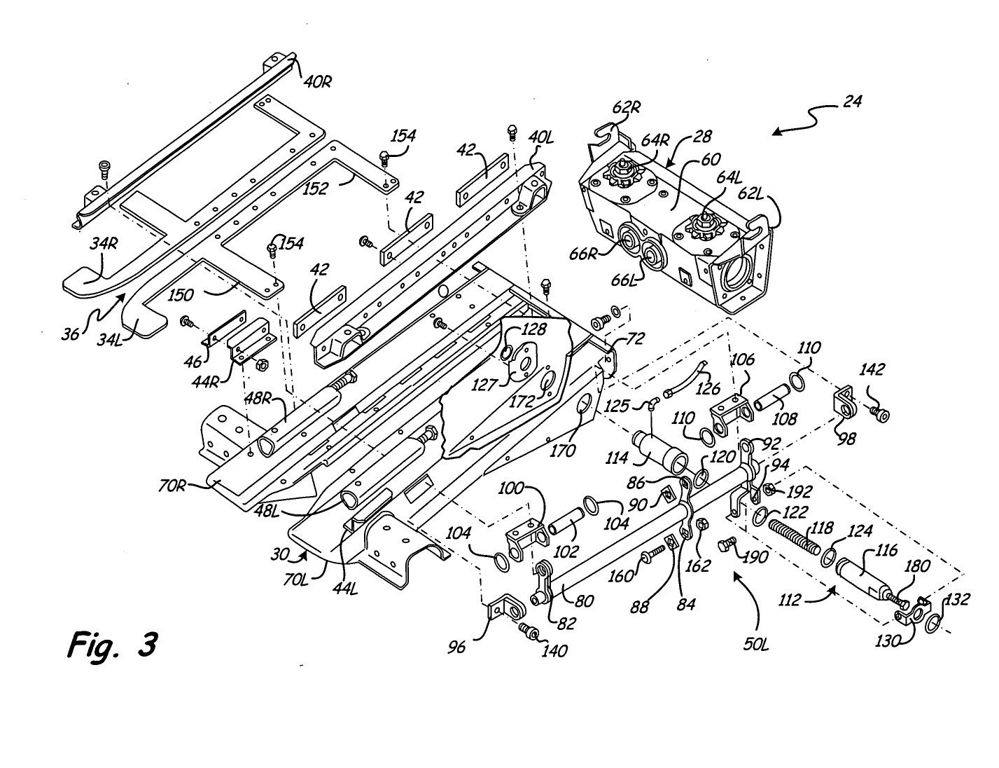

FIG. 3 is an exploded view of row unit 24 with some parts removed and portions broken away. In particular, chains 32L and 32R and their front end sprocket mechanisms are not shown. In addition, the stalk rolls which are positioned below deck plates 34L and 34R are also not shown in FIG. 3.

Row unit 24 includes main gear box 28, row unit frame 30, left and right deck plates 34L and 34R, chain guides 40L and 40R, wear plates 42, brackets 44L and 44R, wear plates 46, chain tensioning spring housings 48L and 48R, and a pair of deck plate tensioning mechanisms, of which mechanism 50L associated with deck plate 34L is shown. A similar tensioning mechanism associated with deck plate 34R is positioned on the opposite side of frame 30, and is not shown in FIG. 3.

Gear box 28 is connected to a transverse drive train, and provides drive power to chains 32L and 32R, and the pair of stalk rolls. Gear box 28 includes housing 60 with mounting brackets 62L and 62R located at opposite ends. Within housing 60 is a drive shaft that includes pinions on opposite ends for driving sprockets 64R and 64L, and a double ring gear in the middle of the drive shaft for driving stalk roll drive pinions 66L and 66R.

Frame 30 is generally U-shaped, with a pair of parallel rails 70L and 70R and a rear crossbar 72. Gear box 28 is mounted adjacent rear crossbar 72 of frame 30. Rails 70L and 70R define a space between them that extends rearwardly from the forward end of frame 30 to crossbar 72. Deck plates 34L and 34R are positioned over the space between rail 70L and 70R to define gap 36.

Chains 32L and 32R (shown in FIG. 2) extend over the top surfaces of rails 70L and 70R. Chains 32L and 32R are guided on their inner run by guides 40L and 40R and on their outer run by guide brackets 44L and 44R.

Wear plates 42 provide protection between guides 40L and 40R and chains 32L and 32R, respectively. Similarly, wear plates 46 provide wear protection between chains 32L and 32R and guide brackets 44L and 44R, respectively.

The width of gap 36 is critical to the yield. If gap 36 is too large, ears can fall between plates 34 and result in a lower yield. If gap 36 is too small, the stalks can get jammed in corn head 10, and result in a longer harvest time.

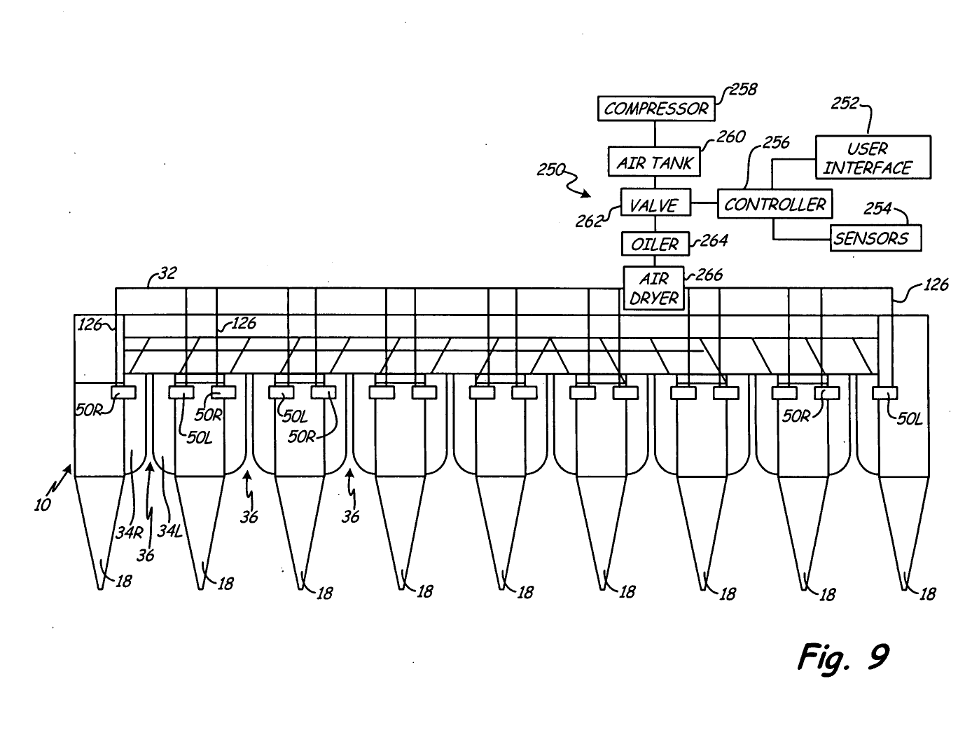

Deck plate tensioning mechanisms 50L is mounted on the outer side of rail 70L, and a similar mechanism 50R (shown in FIG. 9) is mounted on the outer side of rail 70R. Mechanisms 50L, 50R are connected to deck plates 34L, 34R, respectively. Tensioning mechanisms 50L, 50R define the inward most and outward most positions of each deck plate 34L, 34R, as well as the bias force applied to deck plates 34L, 34R in a direction toward their innermost positions. The amount of bias force applied determines the tensioning (i.e. the ability of deck plates 34L, 34R to move apart in response to corn stalks moving through gap 36).

Tensioning mechanism 50L shown in FIG. 3 includes lever shaft 80, crank arm 82, lower cam arm 84, upper cam arm 86, lower cam 88, upper cam 90, crank arm 92, yoke 94, supports 96 and 98, bracket 100, pin 102, snap rings 104, bracket 106, pin 108, snap rings 110, pneumatic actuator 112 (which includes cylinder 114, piston 116, spring 118, inner seal 120, outer seal 122, wear ring 124, pneumatic inlet 125, pneumatic line 126), mounting bracket 127, snap ring 128, bracket 130, and snap ring 132. Tensioning mechanism 50R (shown in FIG. 9) has a similar set of components.

Lever shaft 80 is supported at opposite ends by brackets 96 and 98, which are attached to an outer sidewall of rail 70L by screws 140 and 142, respectively. At the forward end of lever shaft 80, crank arm 82 is connected to bracket 100 by pin 102 and snap rings 104. At the rearward end of lever shaft 80, crank arm 92 is connected to bracket 106 by pin 108 and snap rings 100.

Left deck plate 34L has a pair of arms 150 and 152 that are connected to brackets 100 and 106, respectively, by screws 154. As a result, as lever shaft 80 rotates in a clockwise direction, crank arms 82 and 92 move away from rail 70L, which moves brackets 100 and 106 outward, pulling arms 150 and 152 in an outward direction. This moves deck plate 34L outward, and increases the width of gap 36. Conversely, rotation of lever shaft 80 in a counterclockwise direction moves crank arms 82 and 92, brackets 100 and 106, and deck plate 34L in an inward direction, reducing the width of gap 36.

The outward and inward limits of movement of deck plate 34L are determined by cams 88 and 90, respectively. Cam 88 is connected by bolt 160 and nut 162 to lower cam arm 84. Cam 88 is a square plate with an offset hole, so that cam 88 can be rotated to four possible positions, each defining a different amount of movement of lever 80 in the clockwise direction. As lever shaft 80 rotates in the clockwise direction, cam arm 84 moves toward the sidewall of rail 70L until a lobe of cam 88 engages the sidewall of 70L. This limits the extent of movement of lever shaft 80 in the clockwise direction, which in turn limits the amount of movement of crank arms 82 and 92 in an outward direction. Thus, cam 88 sets the outermost limit of movement of deck plate 34L.

Cam 90 is attached to upper cam arm 86 in a similar fashion. Depending on the position of cam 90, one of four possible innermost positions of deck plate 34L is defined. Depending on orientation of cam 90, one of its lobes engages sidewall of rail 70L to provide a limit to the amount of counterclockwise rotation of lever shaft 80.

Pneumatic actuator 112 provides a biasing force to lever shaft 80. The innermost end of cylinder 114 extends through holes 170 and 172 in sidewalls of rail 70L. The innermost end of cylinder 114 is captured and held in place by bracket 127 and snap ring 128.

Spring 118 and the inner end of piston 116, along with inner seal 120 and outer seal 122 and wear ring 124 are located within cylinder 114. The outer end of piston 116 is attached to bracket 130 by snap ring 132. Bracket 130 is attached to the arms of yoke 94.

Pneumatic actuator 112 applies an outward force through piston 116. This outward force is transferred by bracket 130 to yoke 94, and provides a bias force tending to rotate lever 80 in a counterclockwise direction. Thus, a bias force in a direction toward the inner limit position is applied to deck plate 34L.

The amount of bias force being applied by actuator 112 is determined by the compression of spring 118 and the pneumatic pressure that is supplied through pneumatic line 126 and pneumatic inlet 125 to cylinder 114. The amount of spring compression can be adjusted by adjustment screw or bolt 180 at the outer end of piston 116. The amount of pneumatic pressure can be controlled by the combine operator from the cab of the combine through a control panel or other user interface, or may be controlled automatically based upon sensor inputs. This will be discussed later in conjunction with FIG. 9.

In general, the higher the pneumatic pressure supplied to cylinder 114, the greater the bias force tending to move deck plate 34L toward its innermost position and tension resisting movement of deck plate 34L in an outward direction. When no pneumatic pressure is being applied, only the spring force of spring 118 needs to be overcome.

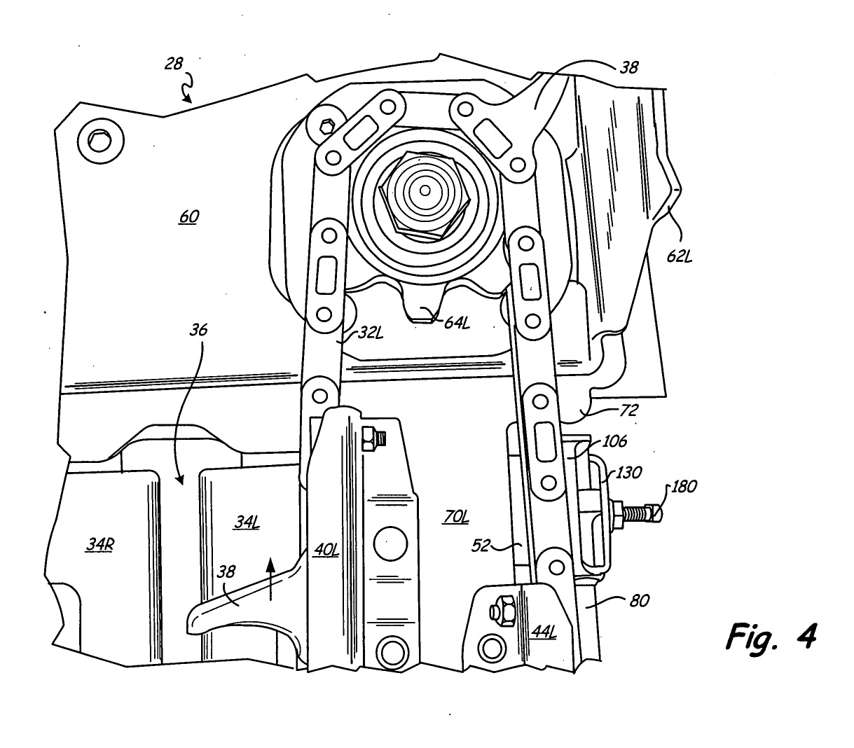

FIG. 4 shows a top view of the left rear portion of row unit 24. A portion of gear box 28 is shown including housing 60, left bracket 62L, and sprocket 64L. Chain 32L, with lugs 38, is shown extending around sprocket 64. On inner run, chain 32L is guided by guide 40L. On its outer run, chain 32L is guided by guide 44L.

Deck plates 34L and 34R are shown at the rearmost portion of row unit 24. Gap 36 can be seen between the inner edges of deck plates 34L and 34R. Also seen in FIG. 4 is an outermost portion of arm 152 of deck plate 34L, which extends under chain 32L and is attached to bracket 106.

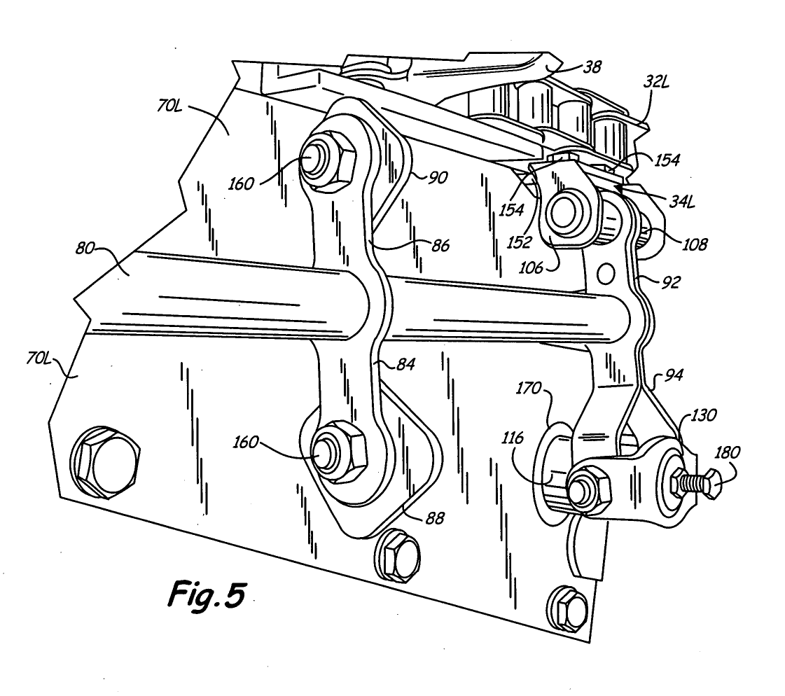

FIG. 5 shows another view of tensioning mechanism 50L. In FIG. 5, lever shaft 80 can be seen along with lower cam arm 84 and upper cam arm 86 and cams 88 and 90. At the rearward end of lever shaft 80, crank arm 92 is connected through pin 108 to bracket 106. Screws 154 connect the outer end of arm 152 of left deck plate 34L to bracket 106.

Yoke 94 is connected to bracket 130, which receives the outer end of piston 116. The combination of pneumatic pressure and spring force within cylinder 114 pushes piston 116 outward and applies force through bracket 130 to the lower end of yoke 94. As shown in FIG. 5, lever shaft 80 has been rotated until a lobe of upper cam 90 engages the outer sidewall of rail 70L. This defines the innermost position of deck plate 34L.

Outward force against deck plate 34L will cause force to be applied by arm 152 to bracket 106 to apply a torque in a clockwise direction to lever shaft 80. If the force being applied in an outward direction by arm 152 of deck plate 34L is sufficient to overcome the combined force of spring 118 and the pneumatic pressure within cylinder 114, piston 116 will move in an inward direction, allowing rotation of lever shaft 80 in a clockwise direction. That will allow movement of deck plate 34L in an outward direction, which rotates lever shaft 80 so that cam 90 is out of engagement with the wall of rail 70L. Rotation of lever shaft 80 can continue, if a net outward force continues to be applied, until a lobe of lower cam 88 engages the outer sidewall of rail 70L. At that point, outward movement of deck plate 34L is stopped because it has reached its outer limit.

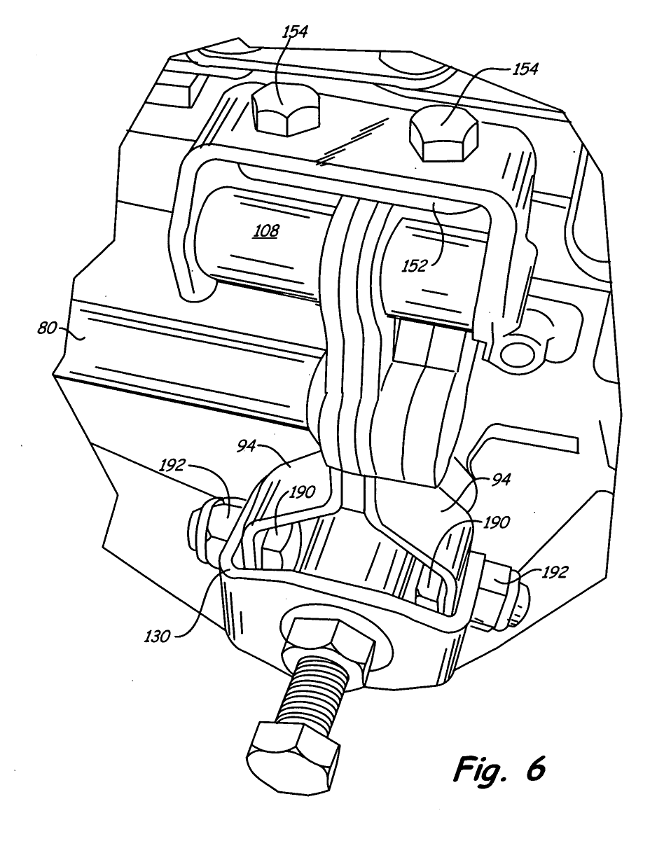

FIG. 6 shows another view in which the connection of bracket 106 to arm 152 by screws 154 can be seen. Also shown in FIG. 6 is the connection of yoke 94 to the ends of bracket 130 by bolts 190 and nuts 192.

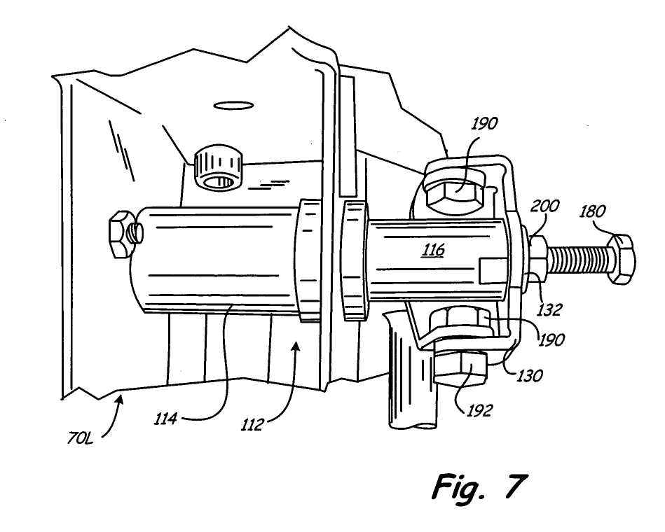

FIG. 7 is a bottom view showing the mounting of cylinder 114 and piston 116 to rail 70L and to bracket 130. Locknut 200 is used in conjunction with adjustment screw 180 and ring 132 in setting the amount of spring compression used in conjunction with the pneumatic pressure provided by actuator 112.

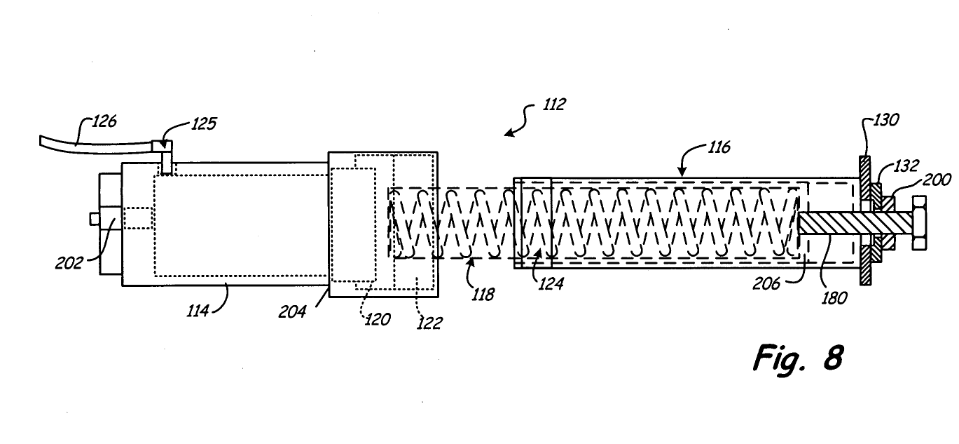

FIG. 8 shows the details of pneumatic actuator 112, which includes cylinder 114, and piston rod 116, spring 118. Grease zerk 202 allows grease to be inserted into cylinder 114 to lubricate the system, as is known by one skilled in the art. Inner seal 120 keeps the air pressure in cylinder 114, while outer seal 122 keeps dust and dirt out of cylinder 114. Inner seal 120 and outer seal 122 are located within wear ring 204.

Fitting 125 connects pneumatic line 126 to cylinder 114. For example, fitting 125 may be mounted in a hole drilled through the wall of cylinder 114 or may be connected to grease zerk 202. To increase the bias force applied to piston 116, air is supplied from pneumatic line 126, through fitting 125 and into cylinder 114. The increased air pressure in cylinder 114 makes it more difficult to push piston rod 116 into cylinder 114, thereby increasing the bias force on deck plate 34L. Other methods of connecting pneumatic line 126 to cylinder 114, which are known to one skilled in the art, may be used.

Piston rod 116 carries wear ring 124, washer 206, bolt 180, and jam nut 200. Washer 206 is attached to the end of bolt 180. Bolt 180 pushed washer 206 inward to compress tension spring 118, and jam nut 200 locks bolt 180 in place. The increased compression of tension spring 118 applies more bias force on deck plate 34L. The compression of tension spring 118 is manually adjusted by loosening jam nut 200 rotating bolt 180 to the new setting and tightening jam nut 200. Tension spring 118 may work in conjunction with other sources of biasing force or alone. For example, tension spring 118 may establish the lowest biasing force that is applied to deck plate 34L and air pressure is used to supplement this biasing force. Tension spring 118 is also a backup tension adjusting device pneumatic pressure fails. This allows the operator to continue utilizing a specific tension on deck plates 34L and 34R, but the tension must be manually set by turning bolt 180.

FIG. 9 shows a schematic diagram of corn head 10 equipped with one embodiment of deck plate tension control system 250. In this embodiment, deck plate tension (determined by bias forces provided by tensioning mechanisms 50L and 50R) is controlled pneumatically.

Tension control system 250 includes user interface 252, sensors 254, controller 256, compressor 258, air tank 260, electronic control valve 262, oiler 264, and air dryer 266. Compressor 258 and air tank 260 are connected together to provide the air pressure necessary for tensioning mechanisms 50L and 50R. Air tank 260 is connected through electronic control valve 262 to oiler 264 and air dryer 266. Electronic control valve 262 is controlled by controller 256 to adjust the pneumatic pressure supplied to actuators 112 of tensioning mechanisms 50L and 50R. When valve 262 opens pressurized air flows from compressor 258 and air tank 260 into oiler 264. Oiler 264 adds oil to the air to lubricate the system. After oiler 264, the air flows into air dryer 266, which removes moisture from the air. The air then flows through pneumatic line 126 to actuators 112 of tensioning mechanisms 50L and 50R.

In the embodiment shown in FIG. 9, all tensioning mechanisms 50L and 50R receive the same pneumatic pressure, and the tensioning of each gap 36 will be the same. In other embodiments, each pair of tensioning mechanisms 50L and 50R are controlled individually (through the use of additional valves controlled by controller 256), so that each pair of deck plates 34L and 34R has its tension individually controlled.

Controller 256 is remotely mounted from tensioning mechanisms 50L and 50R, such as in the cab of the combine. This allows the operator to change the deck plate tension without having to stop the combine, get out, and make mechanical adjustments at each tensioning mechanism 50L and 50R. In one embodiment, controller 256 receives inputs from the operator through user interface 252, which allows the operator to decide whether and by how much to adjust the tension. The operator enters the correct amount of tension through user interface 252, and controller 256 sends a control signal to electronic control valve 262 as described above.

Controller 256 may also control tensioning as a function of signals from sensors 254. The signals from sensor 254 may represent weather condition variables such as humidity and temperature. Sensor 254 may also measure variables of the crop, such as the moisture of the stalks. Controller 256 uses at least one variable to calculate what the tension should be and sends a control signal to valve 262. Controller 256 may also provide control of tensioning based upon both user inputs and sensed inputs.

Controller 256 may communicate with user interface 252 and sensor 254 wirelessly. This may allow an operator to provide user inputs to adjust tension while the operator is away from the cab of the combine.

Tension control system 250 enables the tension on deck plates 34L, 34R to be adjusted remotely. It also enables substantially simultaneous tension adjustment of all or a select number of deck plates 34L, 34R. It enables each actuator 112 to be set at the same tension, which was hard to achieve by individual adjustment. Each of these features save time and energy during harvest because the operator does not have to hand adjust the tension of each individual piston. Additionally, the yield may be increased due to the more effective corn head.

Tension control system 250 does not have to use pneumatics to adjust the biasing force on deck plates 34L, 34R. For example, hydraulics may be used to adjust the tension. In this embodiment, the hydraulics necessary are run off of the hydraulics of the combine and an accumulator is added to tension control system 250 as a shock absorber. Alternatively, the tension may be adjusted using electric actuators. For example, mini electric actuators may replace pneumatic actuators 112, and the pressure of the mini electric actuators can be changed by electrical control signals. Other methods of producing a biasing force also may be used.

Although the present invention has been described with reference to exemplarily embodiments, workers skilled in the art will recognize that changes may be made in form and detail without departing from the spirit and scope of the invention.

1. A corn head for a corn harvester comprising:
a plurality of pairs of left and right deck plates, each pair separated by a gap; and
a tension control system for adjusting tensioning of the pairs of left and right deck plates in response to an input signal.

2. The corn head of claim 1, wherein the tension control system comprises:
tensioning mechanisms connected to the deck plates; and
a controller for controlling bias force applied by the tensioning mechanisms to the deck plates as a function of the input signal.

3. The corn head of claim 2, wherein the controller controls the bias force applied by the tensioning mechanisms by supplying a variable fluid pressure to the tensioning mechanisms.

4. The corn head of claim 2, wherein the tensioning control system further comprises:
a user interface for providing the input signal to the controller based on user inputs.

5. The corn head of claim 4, wherein the tensioning control system further comprises:
a sensor for sensing a variable and providing the input signal to the controller as a function of the variable.

6. The corn head of claim 5, wherein the variable sensed by the sensor is a weather-related variable.

7. The corn head of claim 5, wherein the variable sensed by the sensor is a crop-related variable.

8. The corn head of claim 2, wherein the tensioning mechanisms comprise a left tensioning mechanism connected to the left deck plate and a right tensioning mechanism connected to the right deck plate.

9. The corn head of claim 8, wherein the left tensioning mechanism applies a bias force to the left deck plate in a direction toward the right deck plate, and the right tensioning mechanism applies a biasing force to the right deck plate in a direction toward the left deck plate.

10. The corn head of claim 9, wherein the left and right tensioning mechanisms include actuators, controlled by the controller, for producing the bias forces.

11. The corn head of claim 10, wherein the actuators are one of pneumatic actuators, hydraulic actuators, and electric actuators.

12. The corn head of claim 11, wherein the actuators include a spring.

13. A corn head for a corn harvester comprising:
a plurality of pairs of left and right deck plates, each pair separated by a gap;
a tensioning apparatus connected to the left and right deck plates that applies a biasing forces to the deck plates in a transverse direction toward one another; and
a controller connected to the tensioning apparatus for controlling the biasing forces applied to the deck plates based upon an input signal.

14. The corn head of claim 13, and further comprising:
a user interface for providing the input signal based upon a user input.

15. The corn head of claim 13, and further comprising:
a sensor for providing the input signal as a function of a sensed variable.

16. The control system of claim 15, wherein the variable comprises at least one of a weather-related variable and a crop-related variable.

17. The corn head of claim 13, wherein the tensioning apparatus comprises actuators coupled to the left and right deck plates for applying the biasing forces under control of the controller.

18. The corn head of claim 17, wherein the actuators comprise pneumatic actuators having pistons connected to the first and second deck plates, and a tension spring coupled to the piston.

19. A corn head for a corn harvester comprising:
a plurality of pairs of left and right deck plates, each pair separated by a gap;
a tensioning apparatus connected to the left and right deck plates that applies a biasing forces to the deck plates in a transverse direction that tends to minimize the gap; and
a controller connected to the tensioning apparatus to control the biasing forces applied to the left and right deck plats as a function of an input signal.

20. The corn head of claim 19, wherein the input signal comprises at least one of a user input signal and a sensor input signal.
